(19) United States
(12) Patent Application Publication
(10) Pub. No.: US 2005/0141879 A1
(43) Pub. Date: Jun. 30, 2005

(54) Apparatus and method for reproducing AV data based on updated reproduction control information

(75) Inventors: Hyun-kwon Chung, Seoul (KR); Seong-jin Moon, Suwon-si (KR); Sung-wook Park, Seoul (KR); Kwang-min Kim, Anyang-si (KR); Kil-soo Jung, Hwaseong-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/983,889

(22) Filed: Nov. 9, 2004

(30) Foreign Application Priority Data
Nov. 10, 2003 (KR) 2003-79180
Oct. 30, 2004 (KR) 2004-87594

(51) Int. Cl. H04N 5/781

(52) U.S. Cl. 386/95; 386/125

(57) ABSTRACT

An apparatus and method reproduce AV data, wherein reproduction control information of AV data is downloaded via a network or using other methods, and current reproduction control information is updated, so that the AV data is reproduced based on the updated reproduction control information. The apparatus includes a primary information storage medium and a database. The primary information storage medium stores the AV data and reproduction control information of the AV data. The database is created based on the reproduction control information of the AV data that is recorded on the primary information storage medium. The database is updated using received reproduction control information according to a predetermined update command.

### CROSS-REFERENCE TO RELATED APPLICATIONS

This application claims the priority of Korean Patent Application No. 2003-79180, filed on Nov. 10, 2003, and No. 2004-87594, filed on Oct. 30, 2004 in the Korean Intellectual Property Office, the disclosures of which are incorporated herein in their entirety by reference.

### BACKGROUND OF THE INVENTION

1. Field of the Invention

The present invention relates to updating of reproduction control information of audio/video (AV) data, and more particularly, to an apparatus and a method for reproducing AV data, in which reproduction control information of the AV data is downloaded via a network or using other methods to update current reproduction control information of the AV data, and the AV data is reproduced based on the updated reproduction control information.

2. Description of the Related Art

AV data having a read-only data structure is stored in information storage media and is being sold in the marketplace. These information storage media may be, for example, digital versatile disc (DVD)-video discs or blu-ray read only memory (BD-ROM) video discs. Both AV data and reproduction control information thereof are recorded on one information storage medium. The read-only data structure represents a structure in which all the data is recorded in a predetermined format on an information storage medium, and in order to change a portion of the recorded data, the entire data has to be changed.

In other words, when users desire to add new data or delete or change recorded data, every data that refers to data to be added, deleted, or changed should be changed. When AV data and reproduction control information thereof, e.g., information about clips constituting the AV data, are recorded on an information storage medium, if the AV data and its reproduction control information are recorded in a read-only data structure format, it is difficult to add or change clips and contents. Thus, there is a need for manufacturers to make a new information storage medium for such manipulation.

Also, when a new playitem is inserted into a playlist for AV data having a read-only data structure, the integrity of the playlist may be secured only after the entire playlist table size information, the number-of-playlist information, and the entire playitem address information are all updated.

### SUMMARY OF THE INVENTION

The present invention provides an apparatus and a method to reproduce AV data, in which, in addition to the AV data having a read-only data structure which is recorded on an information storage medium, more AV data, reproduction control information of the AV data, and additional information are downloaded via a network and then stored in a secondary information storage medium. Reproduction control information of the AV data having the read-only data structure is updated using the downloaded information, and the AV data having the read-only data structure is reproduced based on the updated reproduction control information.

The present invention also provides an apparatus and a method to reproduce AV data, in which, when reproduction control information of the AV data and additional information that are stored in a primary information storage medium are updated using reproduction control information of AV data and additional information that are downloaded via a network, a database for the reproduction control information of the AV data and the additional information is updated by synchronizing the downloaded data reproduction control information of AV data and the additional information with those that are stored in the primary information storage medium, and the AV data is reproduced based on the updated database.

According to one aspect of the present invention, an apparatus to reproduce audio/video (AV) data comprises a primary information storage medium and a database. The primary information storage medium stores the AV data and reproduction control information of the AV data. The database is created based on the reproduction control information of the AV data that is recorded on the primary information storage medium. The database is updated using received reproduction control information according to a predetermined update command.

According to another aspect of the present invention, an apparatus to reproduce AV data comprises an AV data storing unit and a reproducing unit. On the AV data storing unit, the AV data and reproduction control information of the AV data are recorded. The reproducing unit receives new reproduction control information of the AV data, updates the reproduction control information according to a predetermined update command, and reproduces the AV data based on the updated reproduction control information.

The reproducing unit may download the new reproduction control information via a network.

According to still another aspect of the present invention, a method reproduces audio/video (AV) data. The method comprises downloading reproduction control information, updating current reproduction control information of the AV data using the downloaded reproduction control information according to a predetermined update command, and reproducing the AV data based on the updated reproduction control information.

The updating of the current reproduction control information may comprise storing the downloaded reproduction control information in a secondary information storage medium, locking data to be updated using the stored reproduction control information to prevent the data from being used by another program, updating the locked data, and unlocking the locked data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates an AV data format having a read-only data structure that is recorded on an information storage medium;

FIG. 1B shows changes in data that constitutes a playlist having a read-only data structure when a playitem #3 is inserted into the playlist;

FIG. 2A illustrates a title list table;

FIG. 2B illustrates a navigation command that is stored in an information storage medium on which AV data having a read-only data structure is recorded;

FIG. 3 illustrates a directory structure of an information storage medium in which AV data is stored;

FIG. 4A illustrates a database that is loaded and managed within a primary memory;

FIGS. 4B through 4E are views illustrating addition, replacement, attachment, and deletion of data of a primary information storage medium;

FIG. 5 shows a management portion of a database in an apparatus for reproducing AV data;

FIG. 6 is a flowchart illustrating updating through addition, replacement, attachment, deletion, and detachment;

FIG. 7 is a view illustrating deletion of data;

FIGS. 8A through 8C are views illustrating various methods to update a database according to embodiments of the present invention;

FIG. 9 is a view illustrating application programming interfaces (API) that update a database by checking if a system is totally updated and rebooted;

FIG. 10 is a block diagram of an apparatus to reproduce AV data that is recorded on an information storage medium in accordance with an embodiment of the present invention; and

FIG. 11 is a view illustrating procedures of storing a database of the primary memory in a secondary information storage medium and loading and updating the database.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

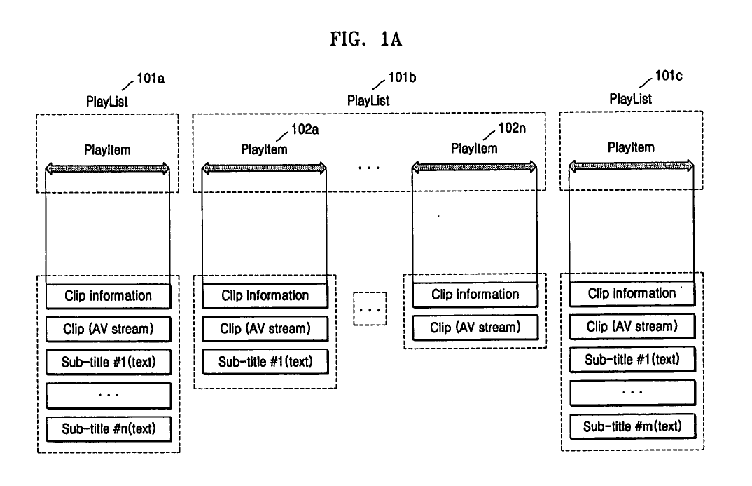

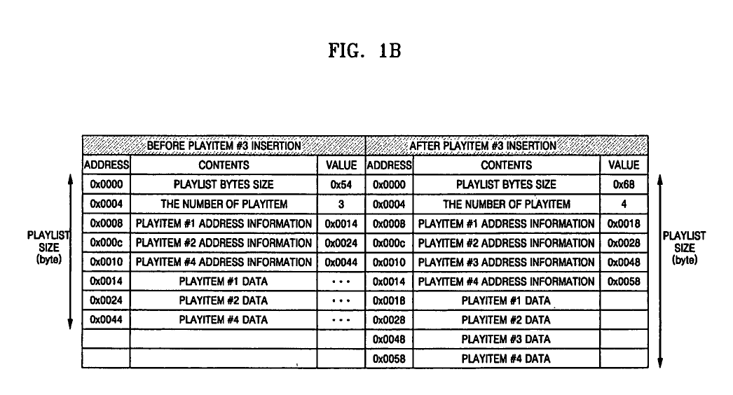

FIG. 1A illustrates an AV data format having a read-only data structure that is recorded on an information storage medium. AV data is recorded in units of a clip and reproduced in units of each of playlists 101a through 101c or playitems 102a through 102n. Here, when compared to conventional DVDs, a clip corresponds to a cell that is a recording unit, and each of playlists or playitems corresponds to a program or a cell that is a reproduction unit. In other words, AV data is recoded in units of a clip on an information storage medium.

Characteristic information of AV data is recorded on a clip information area of each clip. An entry point map is recorded in the clip information area. In the entry point map, information to match audio/video attribute information of each clip with a presentation time stamp (PTS) indicating the time at which each clip is reproduced is recorded. A playlist is a base unit for reproduction, and an information storage medium stores at least one playlist. One movie may have one playlist or several playlists.

A location corresponding to a portion to be reproduced is searched from a clip using reproduction control information of the clip. The reproduction control information of the clip is referenced by designating in time and out time in reproduction control information of a playitem and is processed within the apparatus for reproducing AV data.

FIG. 1B shows changes in data that constitutes a playlist having a read-only data structure when a playitem #3 is inserted into the playlist. It may be seen from FIG. 1B that all the data that constitutes a playlist should be updated if a playitem is added to the playlist. In other words, if one playitem is added to a playlist composed of 3 playitems, playlist size information, the number-of-playitem information, and address information are all changed.

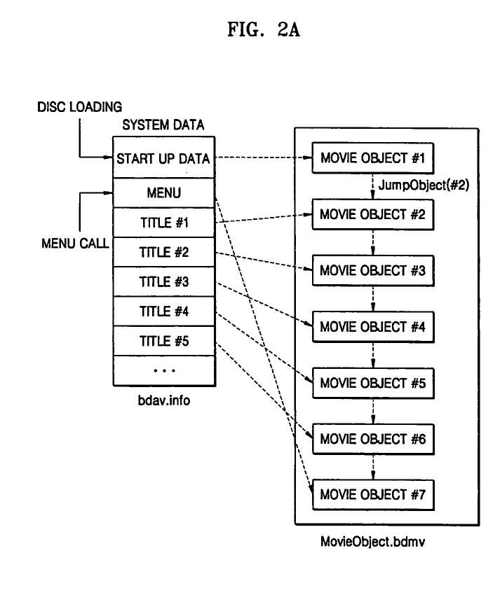

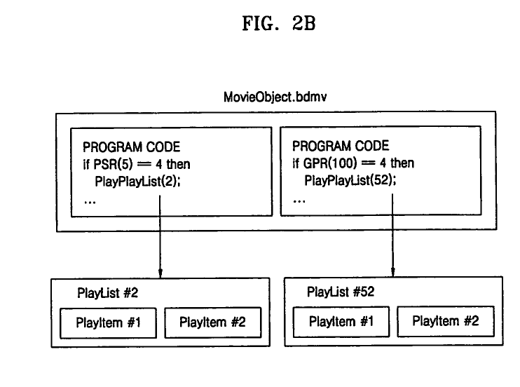

FIG. 2A illustrates a title list table. The title list table includes titles that are stored in an information storage medium on which AV data having a read-only data structure is recorded. Each of the titles indicates an object in which a navigation command is recorded, and once a command to reproduce a corresponding title is issued, the navigation command of a corresponding object is executed.

FIG. 2B illustrates a navigation command that is stored in an information storage medium on which AV data having a read-only data structure is recorded. The navigation command is written in a programming language and contains information about which playlist would be reproduced in each case.

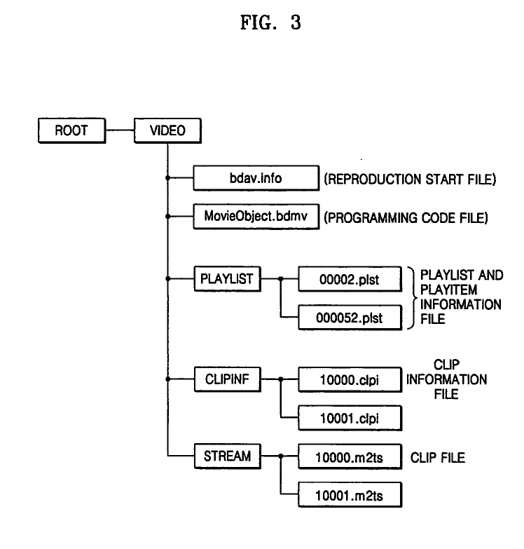

FIG. 3 illustrates a directory structure of an information storage medium in which AV data is stored. In other words, FIG. 3 illustrates a directory structure when the AV data that are constructed as shown in FIGS. 1A, 2A, and 2B are recorded on an information storage medium like an optical disc. An apparatus to reproduce AV data according to an embodiment of the present invention reads content files having such a directory structure and video reproduction control information such as playlists and playitems into a primary memory prior to reproduction of AV data and analyzes the same. Thus, information recorded on a primary information storage medium is previously stored in the primary memory in the form of a database that is managed by the apparatus that reproduces AV data. In a secondary information storage medium, reproduction control information and video clip files that are received via a network and the content files and video reproduction control information such as playlists and playitems that are read into the primary memory are stored.

The apparatus to reproduce AV data analyzes the content files, playlists, and playitems that are recorded on the primary information storage medium and stores the same in the form of a database in the primary memory, and analyzes the content files, playlists, and playitems that are downloaded and updated in the secondary information storage medium, and updates the database of the primary memory. The database is reconstructed every time the apparatus to reproduce AV data is turned on or off. To prevent such reconstruction, the database may be recorded in the secondary information storage medium and loaded in the primary memory.

As described above, the apparatus to reproduce AV data may download video clips, reproduction control information of clips, reproduction control information of playitems, reproduction control information of playlists, and reproduction control information of navigation via a network and may update a database using the downloaded information.

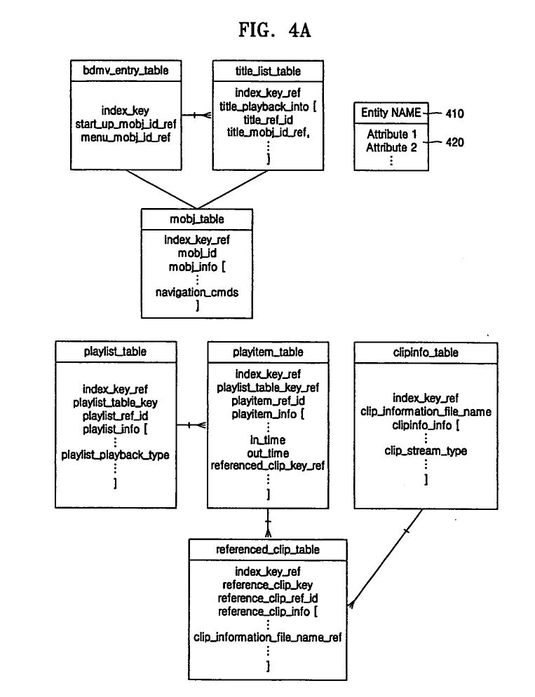

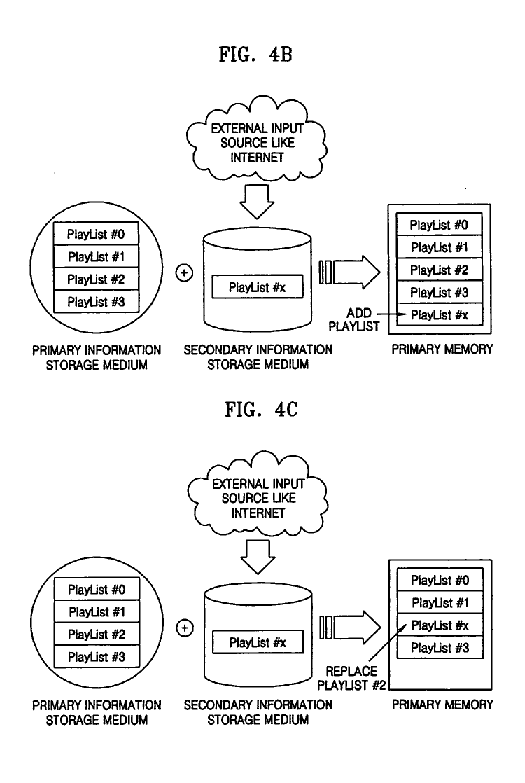

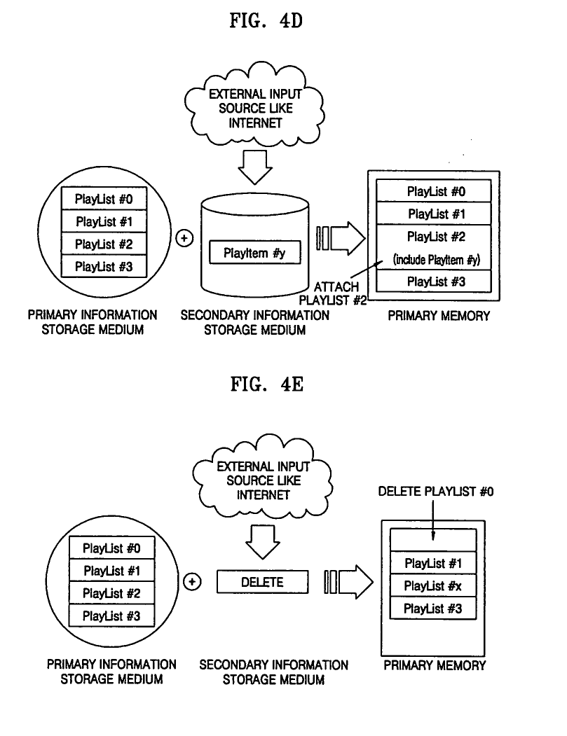

FIG. 4A illustrates a database that is loaded and managed within the primary memory. As shown in FIG. 4A, the database includes entities and attributes in terms of logic and includes records and fields in terms of a computer file. Such a structure of the database facilitates addition, replacement, attachment, and deletion.

FIGS. 4B through 4E are views illustrating addition, replacement, attachment, and deletion of data of the primary information storage medium. Addition of data is adding data that is not present in the primary information storage medium. Referring to FIG. 4B, a playlist #x that is not present in the primary information storage medium is downloaded via a network and recorded on the secondary information storage medium. Thereafter, when the playlist #x is transferred to the primary memory, it is added to the database, thus updating attribute information of the database.

Replacement of data is replacing data that is present in the primary information storage medium with other data. Referring to FIG. 4C, a playlist #2 that is present in the primary information storage medium is downloaded via a network and is replaced with a playlist #2 that is recorded on the secondary information storage medium, thus updating attribute information of the database.

Attachment of data is attaching sub data to data that is present in the primary information storage medium. Referring to FIG. 4D, attachment is used when another playitem #y is attached to the playlist #2 in addition to playitems included in the playlist #2. When using replacement, the playlist #2 should be newly created. In the case of attachment, on the other hand, attribute information of the database may be updated without newly creating the playlist #2 when only a portion of playitems is to be added to a playlist.

Deletion of data is deleting data that is present in the primary information storage medium. Referring to FIG. 4E, an elimination command to eliminate a playlist #0 is received and the playlist #0 is deleted, thus updating the attribute information of the database.

Detachment of data is detaching data and then attaching the data to the database when necessary. For example, a playlist #1 is detached and reproduced if necessary and is then attached to the database again. In this case, the detached reproduction control information, i.e., the playlist #1, is stored in the primary memory or the secondary information storage medium.

A database in which final data that is generated by combining data of the primary information storage medium and the secondary information storage medium is managed and stored in the primary memory of the apparatus that reproduces AV data. When the power is turned on or off, the database is reconstructed. To avoid such an inconvenience, the database may be recorded in the secondary information storage medium instead of the primary memory and later loaded to the primary memory.

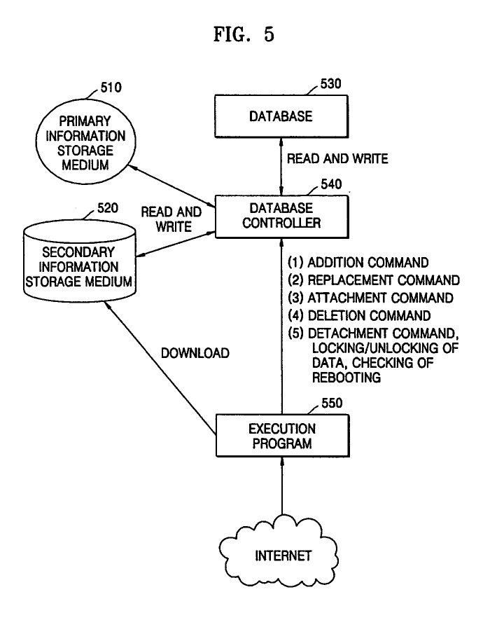

The above-described updating is managed by a program that is executed in the apparatus that reproduces AV data. The database is updated by a database controller. Such updating will be described in detail with reference to FIG. 5. FIG. 5 shows a portion for management of the database in the apparatus that reproduces AV data. AV data and reproduction control information thereof are stored in a primary information storage medium 510. The primary information storage medium 510 may be an optical disc that is read only or is both read and written thereto. A secondary information storage medium 520 stores information that is downloaded via a network such as the Internet and is required for updating. Also, database information to be loaded in the primary memory is stored in the secondary information storage medium 520. An execution program 550 executes operations related to updating of data. A database controller 540 receives a command from the execution program 550 and executes addition, replacement, attachment, deletion, and detachment commands. A database 530 stores data that are constructed according to those commands.

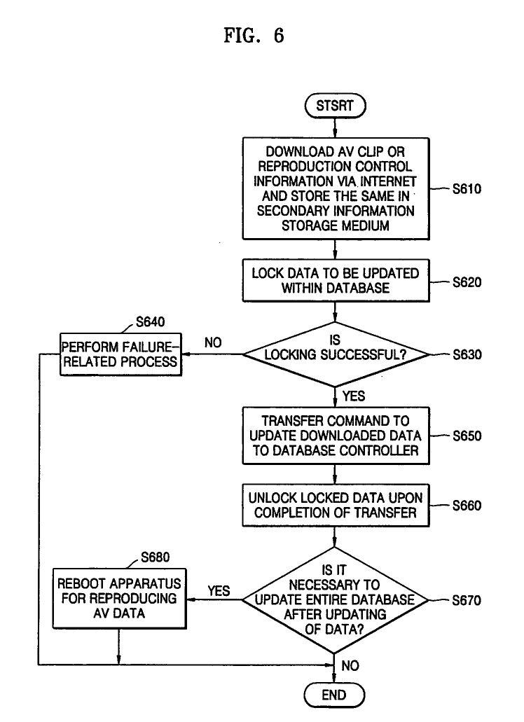

FIG. 6 is a flowchart illustrating updating through addition, replacement, attachment, deletion, and detachment. In operation S610, AV clips or reproduction control information are downloaded via the Internet by a program that is executed within the apparatus that reproduces AV data and are stored in the secondary information storage medium. In operation S620, the program locks data that is related to the downloaded data within the database, so as to prevent the data from being used by another program that is executed within the apparatus that reproduces AV data. It is determined whether locking is successful in operation S630, and if locking fails, a failure-related process is performed, and updating is terminated in operation S640. If locking is successful, the database is updated using data stored in the secondary information storage medium by using one of the above-described updating methods (addition, replacement, attachment, deletion, and detachment) in operation S650.

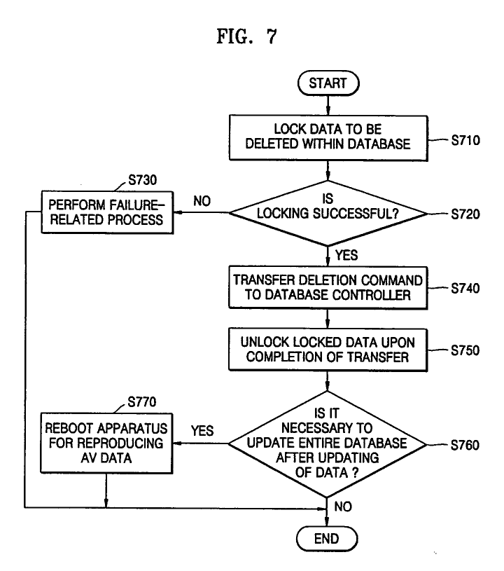

Updating through deletion will be described with reference to FIG. 7. In operation S660, the database that is locked in connection with the downloaded data is unlocked for use in another program. It is determined whether the entire database is needed to be updated after updating of data in operation S670. If necessary, the entire database is updated or the apparatus that reproduces AV data is rebooted in operation S680. The entire database is updated because if a portion of data is updated, various information shown in FIG. 3 should also be updated.

FIG. 7 is a view illustrating deletion of data. In operation S710, data that is related to data to be deleted is locked within the database. It is determined whether locking is successful in operation S720, and if locking fails, a failure-related process is performed and updating is terminated in operation S730. If locking is successful, a program transfers a deletion command to the database controller in operation S740. Thereafter, the locked data is unlocked in operation S750. It is determined whether the entire database is needed to be updated after updating of the corresponding data in operation S760. If necessary, the entire database is updated or the apparatus that reproduces AV data is rebooted in operation S770.

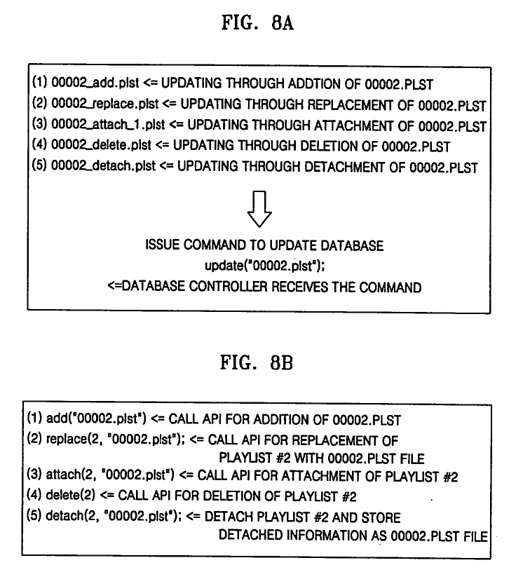

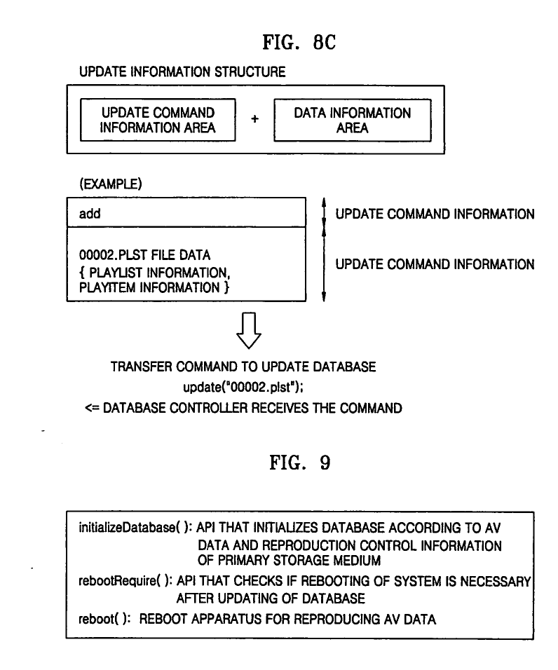

FIGS. 8A through 8C are views illustrating various methods to update a database according to embodiments of the present invention. Referring to FIG. 8A, an addition command, a replacement command, and an attachment command are expressed with file names and are transmitted to a database to update the database. In other words, files are downloaded and predetermined meanings to update the database are given to file names, thus updating the database. The program informs the database controller of what is to be updated by transmitting update commands and file names to the database.

As another way of updating, referring to FIG. 8B, the database information is updated using a command API to update the database. In other words, addition, replacement, attachment, and deletion commands are executed by commands to add, replace, attach, detach, and delete APIs.

As yet another way of updating, referring to FIG. 8C, update information that is constructed in a predetermined structure format is transmitted to the database controller and updated. The update information includes an update command information area and a data information area. For example, in the case of addition of data, a command “add” is stored in the update command information area and data 00002.plst to be added is stored in the data information area. Then, the update command update (“00002.plst”) to update the database is transferred, and the database controller receives the update command and updates the database.

FIG. 9 is a view illustrating application programming interfaces (APIs) that update a database by determining if a system is totally updated and rebooted. Rebooting is performed using the following APIs: initializeDatabse( ), which is an API that initializes the entire database; rebootRequired( ), which is an API that checks if rebooting of the system is needed after updating of the database; and reboot( ), which is an API that reboots the apparatus that reproduces AV data.

In the present invention, the secondary information storage medium is required when the primary information storage medium is read only. Thus, if the primary information storage medium is a recordable medium, it may be used as the secondary information storage medium. In the present invention, the execution program refers to an operable program that is a combination of codes having a command scheme. For example, the execution program may be an execution file, a java class file, or a javascript program file.

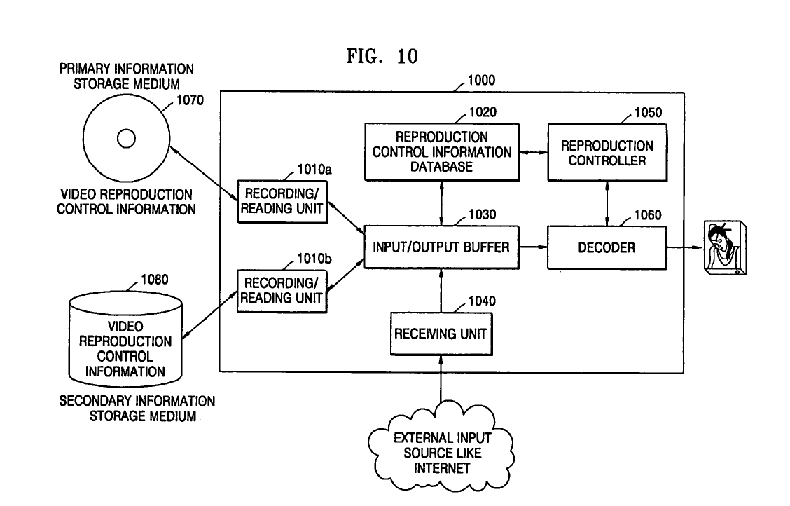

FIG. 10 is a block diagram of an apparatus that reproduces AV data that is recorded on an information storage medium in accordance with an embodiment of the present invention. A receiving unit 1040 receives reproduction control information of AV data via a network. Recording/reading units 1010a and 1010b read reproduction control information of the AV data, which is recorded on a primary information storage medium 1070 and a secondary information storage medium 1080, and record the reproduction control information received via a network. An input/output buffer 1030 transmits the reproduction control information of the AV data from the receiving unit 1040 to the secondary information storage medium 1080. If the primary information storage medium 1070 is a recordable medium, the input/output buffer 1030 may transmit the reproduction control information of the AV data from the receiving unit 1040 to the primary information storage medium 170.

Also, the input/output buffer 1030 creates new reproduction control information by combining the reproduction control information that is recorded on the primary information storage medium 1070 and the secondary information storage medium 1080 and stores the created reproduction control information. The newly created reproduction control information is recorded in a reproduction control information database 1020. Thus, the AV data is transmitted to a decoder 1060 based on the updated reproduction control information, and an AV screen is output. A reproduction control unit 1050 controls selection of AV data to be transmitted to the decoder 1060.

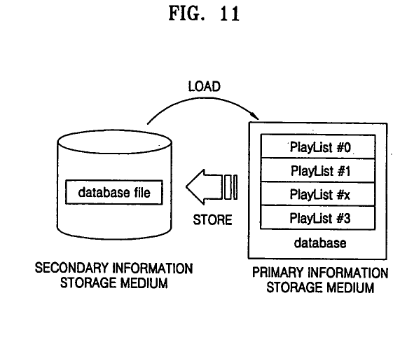

FIG. 11 is a view illustrating procedures of storing a database of the primary memory in the secondary information storage medium and loading and updating the database. Referring to FIG. 11, it may be seen that video reproduction control information is stored in the secondary information storage medium instead of the primary information storage medium and may be loaded to the primary information storage medium at a later time. As described above, the database information obtains data from a read-only data structure and reflects data received via a network, thus updating data having conventional read-only data structures.

According to the present invention, AV data that is generated in a conventional read-only data structure format and reproduction control information are constructed in a relational database structure format and are loaded in the primary memory. Thus, data of the relational database structure may be extracted and updated attribute-by-attribute. As a result, all the functions that are provided by conventional read-only data structures are available. Also, since the database may be managed using interfaces that may update attribute information of the database at a time, contents manufacturers may manufacture updateable contents easily.

Meanwhile, the method to reproduce AV data based on the updated reproduction control information may be embodied as a computer program. Codes and code segments that form the computer program may be easily constructed by computer programmers in the art. The computer program is stored in computer-readable media and is read and executed by a computer, thus implementing the method to reproduce AV data based on the updated reproduction control information. The computer-readable media may include magnetic tapes, optical data storage devices, and carrier waves.

Although a few embodiments of the present invention have been shown and described, it would be appreciated by those skilled in the art that changes may be made in these embodiments without departing from the principles and spirit of the invention, the scope of which is defined in the claims and their equivalents.

1. An apparatus reproducing audio/video (AV) data, the apparatus comprising:
a primary information storage medium storing the AV data and reproduction control information of the AV data; and
a database generated from the reproduction control information of the AV data,
wherein the database is updated using received reproduction control information according to a predetermined update command.

2. The apparatus of claim 1, further comprising a secondary information storage medium storing the database and transferring the database to a primary memory.

3. An apparatus reproducing AV data, the apparatus comprising:
an AV data storing unit on which the AV data and reproduction control information of the AV data are recorded; and
a reproducing unit receiving updated reproduction control information of the AV data, updating the reproduction control information according to a predetermined update command, and reproducing the AV data based on the updated reproduction control information.

4. The apparatus of claim 3, wherein the reproducing unit downloads the updated reproduction control information via a network.

5. The apparatus of claim 4, further comprising a secondary information storage medium storing the updated reproduction control information that is downloaded via the network.

6. The apparatus of claim 5, wherein the reproducing unit combines the reproduction control information stored in the AV data storing unit and the reproduction control information stored in the secondary information storage medium according to the predetermined update command.

7. The apparatus of claim 5, wherein the reproducing unit comprises:
a database controller updating the database according to the predetermined update command using the reproduction control information stored in the AV data storing unit and the secondary information storage medium;
a database storing the updated reproduction control information; and
an updating unit executing a program that executes the predetermined update command.

8. The apparatus of claim 7, wherein the program updates the database using a file name of data that is to be updated.

9. The apparatus of claim 7, wherein the program updates the database using a predetermined application programming interface (API).

10. A method to reproduce audio/video (AV) data, the method comprising:
downloading reproduction control information;
updating current reproduction control information of the AV data using the downloaded reproduction control information by executing a predetermined update command; and
reproducing the AV data based on the updated reproduction control information.

11. The method of claim 10, wherein the updating of the current reproduction control information comprises:
storing the downloaded reproduction control information in a secondary information storage medium;
locking data to be updated using the stored reproduction control information to prevent the data from being used by another program;
updating the locked data; and
unlocking the locked data.

12. The method of claim 10, wherein after the updating of the current reproduction control information, the entire database in which the reproduction control information is stored is initialized or an apparatus that reproduces AV data is rebooted.

13. The method of claim 10, further including, wherein if the predetermined update command is a command to add attribute information of the database to the current reproduction control information:
replacing the current reproduction control information with the attribute information;
attaching the attribute information to the current reproduction control information;
detaching the attribute information from the current reproduction control information; or
deleting the attribute information from the current reproduction control information, and using the reproduction control information received via a network.

14. The method of claim 10, wherein the executing of the predetermined update command includes updating the current reproduction control information using file names in which data including the reproduction control information to be updated is recorded or updating the database using a predetermined application programming interface.

15. A computer readable medium having recorded thereon computer readable instructions to reproduce audio/video (AV) data, the computer readable instructions comprising:
first instructions to store the AV data and reproduction control information of the AV data on a primary information storage medium; and
second instructions to generate a database from the reproduction control information of the AV data and to update the database using received reproduction control information according to a predetermined update command.

16. The computer readable medium of claim 15, further comprising third instructions to store the database on a secondary information storage medium and to transfer the database to a primary memory.

17. A computer readable medium having recorded thereon computer readable instructions to reproduce audio/video (AV) data, the computer readable instructions comprising:
first instructions to record the AV data and reproduction control information of the AV data on an AV data storing unit; and
second instructions to, upon receiving updated reproduction control information of the AV data, update the reproduction control information according to a predetermined update command, and
third instructions to reproduce the AV data based on the updated reproduction control information.

18. The computer readable medium of claim 17, wherein the second instructions include downloading updated reproduction control information via a network.

19. The computer readable medium of claim 18, further comprising fourth instructions storing the updated reproduction control information that is downloaded via the network on a secondary information storage medium.

20. The computer readable medium of claim 19, wherein the fourth instructions combine the reproduction control information stored in the AV data storing unit and the reproduction control information stored in the secondary information storage medium according to the predetermined update command.

21. The computer readable medium of claim 19, wherein the fourth instructions comprise:
a database controller instructions updating the database according to the predetermined update command using the reproduction control information stored in the AV data storing unit and the secondary information storage medium;
storing instructions storing the updated reproduction control information in a database; and
updating instructions implementing a program that executes the predetermined update command.

22. The computer readable medium of claim 21, wherein the program updates the database using a file name of data that is to be updated.

23. The computer readable medium of claim 21, wherein the program updates the database using a predetermined application programming interface (API).

24. A computer readable medium having recorded thereon computer readable instructions to reproduce audio/video (AV) data, the computer readable instructions comprising:
downloading reproduction control information;
updating current reproduction control information of the AV data using the downloaded reproduction control information by executing a predetermined update command; and
reproducing the AV data based on the updated reproduction control information.

25. The computer readable medium of claim 24, wherein the updating of the current reproduction control information comprises:
storing the downloaded reproduction control information in a secondary information storage medium;
locking data to be updated using the stored reproduction control information to prevent the data from being used by another program;
updating the locked data; and
unlocking the locked data.

26. The computer readable medium of claim 24, further including, after the updating of the current reproduction control information, initializing the entire database in which the reproduction control information is stored or rebooting an apparatus that reproduces the AV data.

27. The computer readable medium of claim 24, further including, if the predetermined update command is a command to add attribute information of the database to the current reproduction control information:
replacing the current reproduction control information with the attribute information;
attaching the attribute information to the current reproduction control information;
detaching the attribute information from the current reproduction control information; or
deleting the attribute information from the current reproduction control information, and using the reproduction control information received via a network.

28. The computer readable medium of claim 24, wherein the executing the predetermined update command includes updating the current reproduction control information using file names in which data including the reproduction control information to be updated is recorded or updating the database using a predetermined application programming interface.

29. An apparatus to reproduce AV data, wherein the apparatus is coupled to a network, the apparatus comprising:
a primary information storage medium having a database to store content files that have a directory structure and video reproduction control information including lists and playitems;
a secondary information storage medium, storing reproduction control information, video clip files received via the network, the content files and video reproduction control information including playlists and playitems that are read into the primary memory;
a processor coupled to the primary information storage medium and the secondary information storage medium, to:
read the content files, including playlists and playitems, into the database prior to reproduction of AV data,
analyze the content files, playlists, and playitems;
update the content files, playlists, and playitems in the secondary information storage medium, and update the database of the primary information storage medium,
wherein one of:
the database is reconstructed when the apparatus is turned on or off, or
the database is recorded in the secondary information storage medium and loaded in the primary information medium.
